(19) United States
(12) Patent Application Publication
(10) Pub. No.: US 2026/0035295 A1
(43) Pub. Date: Feb. 5, 2026

(54) ELECTRODEPOSITION SMART WINDOW WITH IMPROVED LIGHT BLOCKING EFFICIENCY

(71) Applicant: Soonchunhyang University Industry Academy Cooperation Foundation, Asan-si (KR)

(72) Inventor: Cheon Woo MOON, Asan-si (KR)

(73) Assignee: Soonchunhyang University Industry Academy Cooperation Foundation, Asan-si (KR)

(21) Appl. No.: 19/287,865

(22) Filed: Aug. 1, 2025

(30) Foreign Application Priority Data
Aug. 1, 2024 (KR) 10-2024-0102650

(51) Int. Cl. C03C 17/36

(52) U.S. Cl. CPC C03C 17/3607; C03C 17/3657; C03C 2217/948; C03C 2218/115

(57) ABSTRACT

An electrodeposition smart window exhibits superior light blocking efficiency compared to conventional smart windows, thereby enabling a significant change in light transmittance even with a small current, and is thus highly advantageous in terms of energy efficiency.

### CROSS-REFERENCE TO THE RELATED APPLICATIONS

This application is based upon and claims priority to Korean Patent Application No. 10-2024-0102650, filed on Aug. 1, 2024, the entire contents of which are incorporated herein by reference.

### TECHNICAL FIELD

The present invention relates to an electrodeposition smart window and, more particularly, to an electrodeposition smart window that exhibits superior light blocking efficiency compared to conventional smart windows, thereby enabling a significant change in light transmittance even with a small current, and is thus highly advantageous in terms of energy efficiency.

### BACKGROUND

In general, a smart window refers to a window that is configured to be switched on and off, and changes its light transmittance when a voltage is applied, thereby controlling the amount of light or heat passing through it. That is, a smart window is configured to change its state to transparent, opaque, or translucent in response to an applied voltage, and is also referred to as variable transmittance glass, dimmable glass, or smart glass.

In addition, a smart window can be used as a partition in indoor spaces or as a skylight installed in an opening of a building, and may also be applied to highway signs, bulletin boards, scoreboards, clocks, or advertisement screens. Furthermore, it can be used as a window or sunroof in vehicles such as automobiles, buses, aircraft, ships, or trains.

Smart windows are classified according to the type of functional material used, including liquid crystal displays (LCD), suspended particle displays (SPD), electrochromic glass (EC), photochromic glass (PC), and thermochromic glass (LTC). As smart windows are emerging as next-generation high-performance and high-value-added products, leading companies and related research institutions are investing substantial budgets to promote their development.

Conventional smart windows are generally manufactured using polymer dispersed liquid crystal (PDLC), which has a structure in which fine liquid crystals (LC) are dispersed within a polymer matrix by injecting the PDLC between a pair of glass substrates. However, in the case of smart windows using liquid crystals, there is a drawback in that prolonged operation results in significant power consumption.

In addition, conventional suspended particle display (SPD) type smart window technologies have drawbacks such as increased thickness due to the use of multilayer transparent electrodes, or low transmittance efficiency. Korean Laid-Open Patent Publication No. 2013-0037600 discloses a smart window technology including a polymer-dispersed liquid crystal device, but it fails to provide a solution to the aforementioned problems.

In addition, in order to efficiently utilize solar energy, which is an eco-friendly energy source, it is essential to adjust the light transmittance itself.

Accordingly, there is a need for the development of a smart window that can efficiently achieve a large change in light transmittance with a small amount of electric energy, thereby exhibiting excellent power efficiency.

### RELATED ART DOCUMENT

### Patent Document

(Patent Document 1) Korean Laid-Open Patent Publication No. 2013-0037600

### SUMMARY

### Technical Problem

The present invention has been proposed to solve the above-described problems, and is directed to providing a smart window having excellent power efficiency by enabling significant modulation of transmittance with the use of a small amount of electric energy.

### Technical Solution

In order to solve the above problems, the present invention provides an electrodeposition smart window, comprising: a substrate; and an electrochromic layer formed on the substrate, wherein, when a voltage is applied, the electrochromic layer comprises a metal nanoparticle array on the substrate, and wherein, for light in a wavelength range of 400 to 2500 nm, the effective refractive index of the metal nanoparticle array is greater than the magnitude (i.e., the absolute value) of the refractive index of a bulk metal of the same kind as the metal nanoparticles for at least a specific wavelength range.

In addition, the metal nanoparticle array may be formed by electrodeposition.

In addition, the specific range may be from 400 nm to 550 nm.

In addition, the metal nanoparticle array may include hemispherical nanoparticles.

In addition, the Q_{LSPR} value of the metal of the same kind as that of the metal nanoparticle array is 1 or more at a wavelength of 550 nm of light.

In addition, the metal nanoparticle array may include one or more selected from the group consisting of Mg, Ag+, Al, Pb, Ti, Zn, W, and Ni.

In addition, an average radius of the metal nanoparticles may range from 10 to 350 nm.

In addition, an average interparticle distance of the metal nanoparticle array may be equal to or greater than 2 times and equal to or less than 8 times an average radius of the metal nanoparticles.

In addition, the substrate may include a transparent base material; and a transparent conductive material coated on an upper surface of the transparent base material.

In this case, the transparent base material may include one or more selected from the group consisting of glass, polyethylene terephthalate (PET), and polyethersulfone (PES).

The transparent conductive material may include one or more selected from the group consisting of ITO (InSnO), InZnO, ZnO, InZnSnO, TiInZnO, NiInZnO, AZO(Al-doped ZnO), BZO(B-doped ZnO), and GZO (Ga-doped ZnO).

In addition, the substrate may further include inert metal nanoparticles coated on an upper surface of the transparent conductive material.

In this case, the inert metal nanoparticles may include one or more selected from the group consisting of Pt, Au, Ru, Rh, Pd, Os, and Ir.

In addition, the transparent conductive material may have a thickness of 50 to 350 nm, and the electrochromic layer may have a thickness of 10 to 1000 nm.

In addition, the electrochromic layer may include an electrolyte layer, and the electrolyte layer may include a solvent and one or more selected from the group consisting of Mg²⁺, Ag⁺, Al³⁺, Pb²⁺, Ti⁴⁺, Zn²⁺, W⁶⁺, and Ni²⁺.

In addition, a real part of a refractive index of the electrolyte layer may be from 1 to 3.

In addition, the electrolyte layer may further include one or more selected from the group consisting of polyvinylpyrrolidone (PVP), cetyltrimethylammonium bromide (CTAB), cetyltrimethylammonium chloride (CTAC), polyethylene glycol (PEG), ethylenediaminetetraacetic acid (EDTA), and bovine serum albumin (BSA).

In addition, the applied voltage may be from −1 V to 1.5 V.

### Advantageous Effect

According to the present invention, an electrodeposition smart window with excellent power efficiency can be provided by enabling a significant modulation of transmittance with the use of a small amount of electric energy.

### BRIEF DESCRIPTION OF THE DRAWINGS

FIG. 1 illustrates a comparison between the effective refractive index of a magnesium nanoparticle array according to an embodiment of the present invention and the absolute value of the refractive index of magnesium in the wavelength range of 400 to 2500 nm.

FIG. 2 illustrates a comparison of the wavelength-dependent transmittance in the wavelength range of 400 to 2500 nm, measured for a magnesium nanoparticle array according to an embodiment of the present invention and a magnesium thin film composed of the same amount of magnesium as the magnesium nanoparticle array.

FIG. 3 is a top view and a side view showing the structure of a magnesium nanoparticle array according to an embodiment of the present invention.

FIG. 4 illustrates a comparison of the wavelength-dependent absorption rates in the wavelength range of 400 to 2500 nm, measured for a magnesium nanoparticle array according to an embodiment of the present invention and a magnesium thin film composed of the same amount of magnesium as the magnesium nanoparticle array.

FIG. 5 illustrates a comparison of the wavelength-dependent reflectance in the wavelength range of 400 to 2500 nm, measured for a magnesium nanoparticle array according to an embodiment of the present invention and a magnesium thin film composed of the same amount of magnesium as the magnesium nanoparticle array.

FIG. 6 illustrates a comparison between the effective refractive index of a magnesium nanoparticle array according to an embodiment of the present invention and the absolute value of the refractive index of magnesium in the wavelength range of 400 to 2500 nm.

FIG. 7 illustrates a comparison of the wavelength-dependent transmittance in the wavelength range of 400 to 2500 nm, measured for a magnesium nanoparticle array according to an embodiment of the present invention and a magnesium thin film composed of the same amount of magnesium as the magnesium nanoparticle array.

FIG. 8 is a top view and a side view showing the structure of a magnesium nanoparticle array according to an embodiment of the present invention.

FIG. 9 illustrates a comparison of the wavelength-dependent absorption rates in the wavelength range of 400 to 2500 nm, measured for a magnesium nanoparticle array according to an embodiment of the present invention and a magnesium thin film composed of the same amount of magnesium as the magnesium nanoparticle array.

FIG. 10 illustrates a comparison of the wavelength-dependent reflectance in the wavelength range of 400 to 2500 nm, measured for a magnesium nanoparticle array according to an embodiment of the present invention and a magnesium thin film composed of the same amount of magnesium as the magnesium nanoparticle array.

FIG. 11A illustrates an analysis of the profile of the E_{Z} electric field component of a magnesium nanoparticle array according to an embodiment of the present invention at a wavelength of 500 nm.

FIG. 11B illustrates an analysis of the profile of the E_{Z} electric field component of a magnesium nanoparticle array according to an embodiment of the present invention at a wavelength of 1000 nm.

FIG. 12 illustrates a comparison of the complex refractive index values of magnesium and chromium.

FIG. 13 illustrates a comparison of the Q_{LSPR} values of magnesium and chromium.

FIG. 14 illustrates a comparison of the wavelength-dependent transmittance in the wavelength range of 400 to 2500 nm, measured for a magnesium nanoparticle array and a magnesium thin film composed of the same amount of magnesium as the magnesium nanoparticle array according to an embodiment of the present invention, and further compares the results with those obtained when chromium is used instead of magnesium.

FIG. 15 illustrates a comparison of the wavelength-dependent transmittance in the wavelength range of 400 to 2500 nm, measured for a magnesium nanoparticle array and a magnesium thin film composed of the same amount of magnesium as the magnesium nanoparticle array according to an embodiment of the present invention, and further compares the results with those obtained when chromium is used instead of magnesium.

FIG. 16 illustrates a comparison of the wavelength-dependent absorption rates in the wavelength range of 400 to 2500 nm, measured for a magnesium nanoparticle array and a magnesium thin film composed of the same amount of magnesium as the magnesium nanoparticle array according to an embodiment of the present invention, and further compares the results with those obtained when chromium is used instead of magnesium.

FIG. 17 illustrates a comparison of the wavelength-dependent absorption rates in the wavelength range of 400 to 2500 nm, measured for a magnesium nanoparticle array and a magnesium thin film composed of the same amount of magnesium as the magnesium nanoparticle array according to an embodiment of the present invention, and further compares the results with those obtained when chromium is used instead of magnesium.

FIG. 18 illustrates the transmittance of a magnesium nanoparticle array according to an embodiment of the present invention, with respect to the real part of the refractive index of an electrolyte and the wavelength of incident light.

FIG. 19 illustrates the transmittance of a magnesium thin film composed of the same amount of magnesium as the magnesium nanoparticle array in FIG. 18, with respect to the real part of the refractive index of an electrolyte and the wavelength of incident light.

### DETAILED DESCRIPTION OF THE EMBODIMENTS

Hereinafter, exemplary embodiments of the present invention will be described in detail so that those of ordinary skill in the art can readily implement the present invention. The present invention may be embodied in many different forms and is not limited to the embodiments set forth herein.

As described above, conventional smart windows have mainly been utilized in a manner that controls light transparency by scattering light using polymers. However, smart windows employing such a method have significant drawbacks in that they consume a large amount of power during long-term operation, and although they can control transparency, they cannot block light transmission itself. As a result, their applicability is significantly limited in fields where controlling the transmission or blocking of solar energy is essential for effective utilization.

Accordingly, the present invention provides an electrodeposition smart window comprising a substrate and an electrochromic layer formed on the substrate, wherein the electrochromic layer includes a metal nanoparticle array on the substrate, and when a voltage is applied, the effective refractive index of the metal nanoparticle array is greater than the absolute value of the refractive index of a bulk metal of the same kind as the metal nanoparticles, for at least a specific wavelength range within the wavelength range of 400 to 2500 nm. Through this configuration, the present invention seeks to address the aforementioned problems. As a result, compared to conventional smart windows, the transmittance can be significantly adjusted with the use of a smaller amount of electric energy, thereby providing excellent power efficiency.

A detailed description will now be given of the electrodeposition smart window according to the present invention.

A smart window is a window whose properties change under specific conditions. In the smart window according to the present invention, when a voltage is applied, a metal nanoparticle array is formed, resulting in a change in light transmittance.

In addition, the metal nanoparticle array is formed on the substrate and is formed within the electrochromic layer. More specifically, the metal nanoparticle array formed on the substrate absorbs the transmitted light, thereby exhibiting an effect of reducing light transmittance. At this time, light is more strongly absorbed due to the surface plasmon phenomenon occurring in the metal nanoparticle array, which results in excellent performance in terms of reducing transmittance.

After the metal nanoparticle array is formed, when a reverse voltage is applied, the previously formed metal nanoparticle array is decomposed, the transmittance is restored, and the smart window returns to its transparent state. That is, depending on the direction, duration, and intensity of the applied voltage, the metal nanoparticle array may be formed or decomposed, thereby allowing the transmittance of the smart window to be freely controlled. In particular, in the case of conventional smart windows using PDLC, continuous current supply is required to maintain a certain level of transparency, resulting in significant power loss. However, in the electrodeposition smart window according to the present invention, once the desired transmittance is achieved by applying a voltage, continuous current supply is no longer required, thereby providing significantly superior electrical efficiency compared to conventional smart windows.

More specifically, the metal nanoparticle array may be formed by electrodeposition. When a voltage is applied to the substrate, metal nanoparticles are deposited on the voltage-applied substrate, thereby forming a specific array. Due to electrodeposition, the metal nanoparticle array may be formed in at least one layer, and depending on the direction, duration, and intensity of the applied voltage, it may be formed as a multilayer structure with up to 100 layers.

More specifically, for light in the wavelength range of 400 to 2500 nm, the effective refractive index of the metal nanoparticle array is greater than the absolute value of the refractive index of a bulk metal of the same kind as the metal nanoparticles for at least a specific range of wavelengths.

As described above, conventional smart windows required a large amount of electric energy to control light transmittance, which posed a significant disadvantage in terms of electrical efficiency. However, the smart window according to the present invention addresses the above-mentioned problem by ensuring that, for light in the wavelength range of 400 to 2500 nm, the effective refractive index of the metal nanoparticle array is greater than the absolute value of the refractive index of a bulk metal of the same kind as the metal nanoparticles for at least a specific range of wavelengths.

When the metal nanoparticles form an array, a surface plasmon phenomenon occurs, enhancing the absorption capability for the incident light.

Surface plasmon refers to two types: surface plasmon polariton (SPP) and localized surface plasmon resonance (LSPR). SPP refers to the quantized oscillation of free electrons propagate along the surface of a conductor, such as the surface of a metal nanoparticle. Such surface plasmons are excited by incident light entering a metal thin film at an angle greater than the critical angle of a dielectric medium, such as a prism, and cause resonance. This phenomenon is referred to as surface plasmon resonance (SPR). The surface plasmons generated in this process propagate along the surface of the metal nanoparticles over several micrometers, and are therefore also referred to as surface plasmon polaritons (SPP).

In addition, metal nanostructures such as metal nanoparticles (nanoparticles or nanodots) exhibit an electric dipole characteristic as collective oscillation of electrons in the conduction band of the nanostructure is induced by incident light of a specific frequency (wavelength) from the outside. As a result, the nanostructure strongly scatters and absorbs light in the corresponding frequency range, a phenomenon known as localized surface plasmon resonance (LSPR).

The stronger the LSPR phenomenon generated by the metal nanoparticle structure, the greater the absorption capability for the incident light, thereby enhancing the electrical efficiency of the electrodeposition smart window.

More specifically, the surface plasmon phenomenon of the LSPR type occurs at an exceptionally high level when the effective refractive index of the metal nanoparticle array is greater than the absolute value of the refractive index of a bulk metal of the same kind as the metal nanoparticles. Accordingly, when comparing the transmittance of a metal nanoparticle array and a metal thin film composed of the same amount and type of metal, the transmittance of the metal nanoparticle array becomes lower than that of the metal thin film.

In conclusion, when the effective refractive index of the metal nanoparticle array is greater than the absolute value of the refractive index of a bulk metal of the same kind as the metal nanoparticles, the transmittance can be significantly adjusted with a small amount of electric energy, resulting in excellent electrical efficiency.

More specifically, the refractive index of the bulk metal of the same kind as the metal nanoparticles may be a conventionally known value, and more particularly, it can be obtained by measuring the refractive index of a metal thin film using an ellipsometer.

In addition, the refractive index may be a complex refractive index. The complex refractive index is expressed as shown in Equation 1 below, where n represents the real part of the complex refractive index and k represents the imaginary part. In this case, the absolute value of the refractive index may refer to the magnitude (i.e., the absolute value) of the complex refractive index, which can be calculated as shown in Equation 2 below.

$$Refractive index = n + k i \qquad 〈 Equation 1 〉$$

n: real part of the complex refractive index
k: imaginary part of the complex refractive index

$$Absolute value of refractive index = {( {n}^{2} + {k}^{2} )}^{1 / 2} \qquad 〈 Equation 2 〉$$

In addition, more specifically, the effective refractive index of the metal nanoparticle array refers to the refractive index measured for the configured metal nanoparticle array, which may be measured using an ellipsometer.

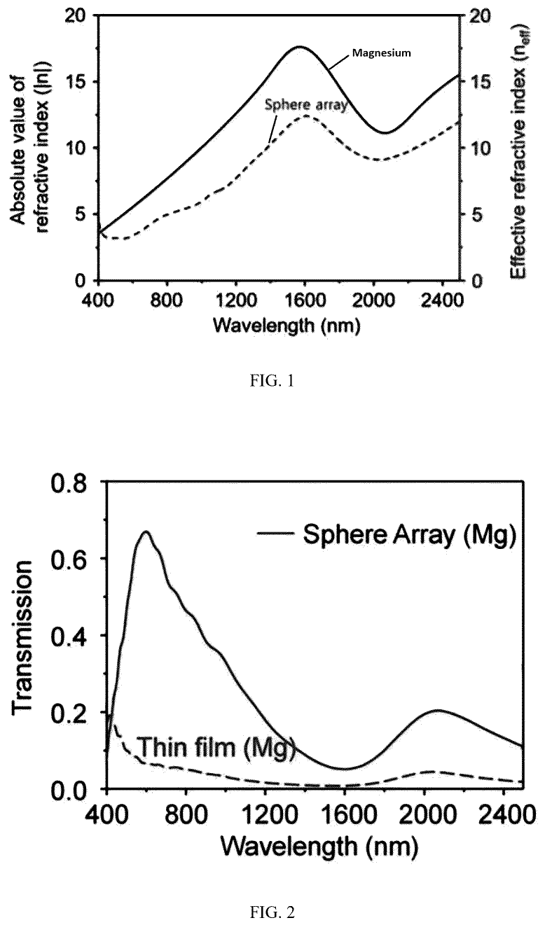

A more detailed explanation will be provided with reference to FIGS. 1, 2, and 3.

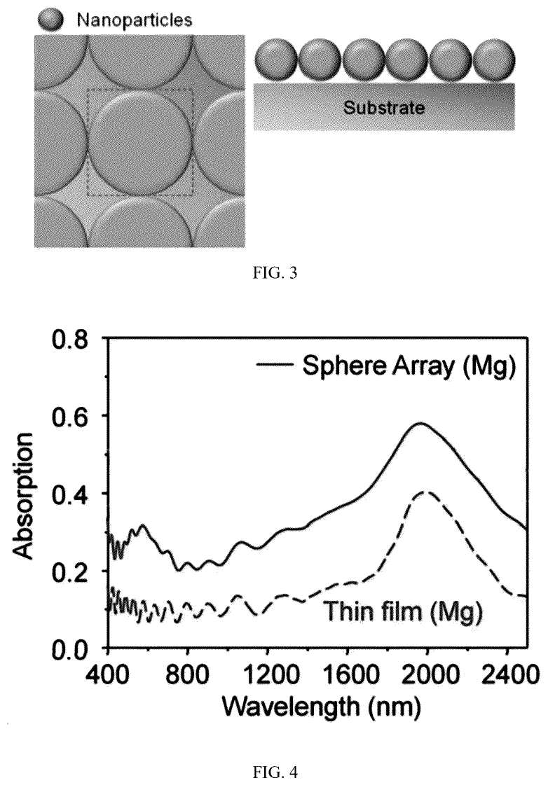

FIG. 1 illustrates the effective refractive index values of a spherical magnesium nanoparticle array and the absolute value of the refractive index of magnesium in the wavelength range of 400 to 2500 nm, and FIG. 2 illustrates the wavelength-dependent transmittance of the magnesium nanoparticle array in the wavelength range of 400 to 2500 nm, in comparison with a magnesium thin film composed of the same amount of magnesium as the magnesium nanoparticle array. In addition, FIG. 3 shows a top view and a side view of the magnesium nanoparticle array.

At this time, the refractive index of magnesium is a conventionally known value, and the value shown was measured using an ellipsometer. In addition, the effective refractive index and transmittance of the magnesium nanoparticle array, as well as the transmittance of the magnesium thin film, were measured using Finite-Difference Time-Domain (FDTD) simulation. For the FDTD simulation measurements, a substrate coated with a 130 nm thick ITO layer on SiO₂ glass was used, and magnesium nanoparticles were formed on the upper surface of the substrate as shown in FIG. 3. The magnesium thin film was also formed on the same type of substrate, using the same amount of magnesium as the magnesium nanoparticle array, and was formed with a uniform thickness. At this time, the magnesium nanoparticles were arranged adjacent to each other, as shown in FIG. 3, and the radius of each magnesium nanoparticle was measured to be 20 nm. In addition, the incident light was p-polarized, with its oscillation direction set parallel to the x-axis, and was directed toward the substrate through the metal nanoparticle array using a wave vector of (k_{+Z}).

As can be seen from FIGS. 1 and 2, in the vicinity of 400 nm where the effective refractive index value of the metal nanoparticle array is greater than the absolute value of the refractive index of a bulk metal of the same kind as the metal nanoparticles, the transmittance of the metal nanoparticle array is lower than that of the metal thin film. In conclusion, when the effective refractive index of the metal nanoparticle array is greater than the refractive index of a bulk metal of the same kind, it provides a significant advantage in reducing light transmittance compared to a metal thin film composed of the same amount of metal. Accordingly, transmittance can be significantly adjusted with the use of a smaller amount of electric energy, resulting in a significant advantage in terms of electrical efficiency.

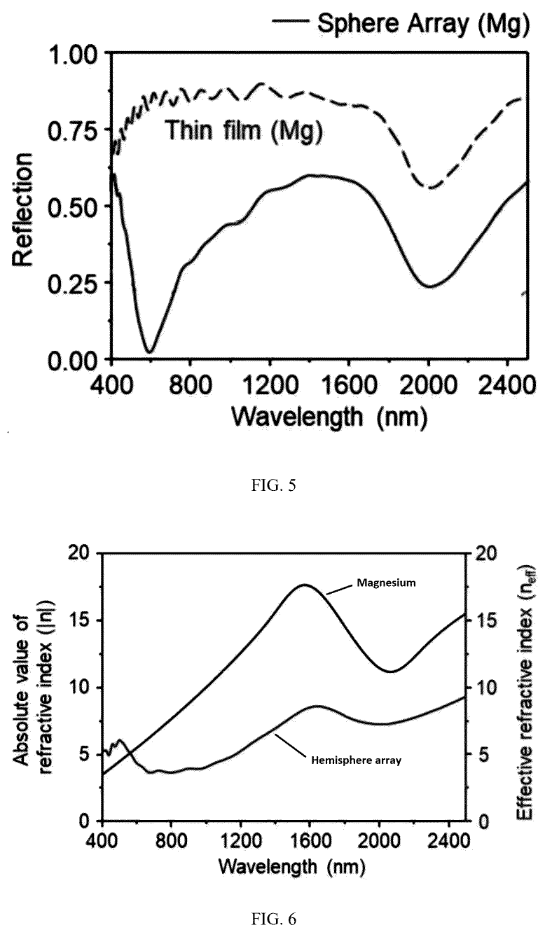

A more detailed explanation will be provided with reference to FIGS. 4 and 5.

FIG. 4 illustrates the results of the same simulation as in FIG. 2, but with the absorption rates of light measured for the magnesium nanoparticle array and the magnesium thin film, and FIG. 5 illustrates the results of the same simulation as in FIG. 2, but with the reflectance of light measured for the magnesium nanoparticle array and the magnesium thin film.

As can be seen from FIG. 4, the magnesium nanoparticle array exhibits significantly enhanced absorption capability compared to the magnesium thin film. This improvement is attributed to the occurrence of surface plasmon effects, which lead to more effective light absorption. In addition, as can be seen from FIG. 5, the reflectance is significantly higher in the region where the effective refractive index value of the magnesium nanoparticle array is greater than the absolute value of the refractive index of magnesium, as compared with FIG. 1. As described above, the metal nanoparticle array exhibits an enhanced absorption pattern compared to the metal thin film due to the occurrence of the surface plasmon phenomenon. Consequently, in the region where the plasmon effect is maximized—specifically, where the effective refractive index of the magnesium nanoparticle array is greater than the absolute value of the refractive index of magnesium—the performance in blocking light transmission is exceptionally superior.

More specifically, the metal nanoparticle array may include hemispherical nanoparticles. As described above, the plasmon phenomenon occurs in the metal nanoparticle array in the form of localized surface plasmon resonance (LSPR). In this case, LSPR occurs on the surface of each metal nanoparticle, specifically in the direction toward adjacent metal nanoparticles. In this case, compared to other shapes of nanoparticles, hemispherical nanoparticles exhibit a more pronounced LSPR effect, leading to more active plasmon phenomena and, consequently, more effective blocking of light transmission.

A more detailed explanation will be provided with reference to FIGS. 6, 7, and 8.

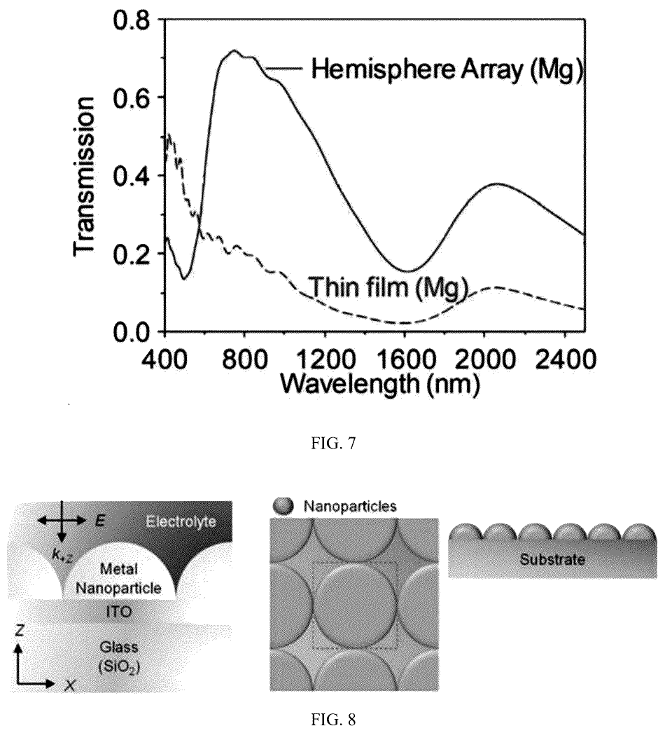

FIG. 6 illustrates the effective refractive index values of a hemispherical magnesium nanoparticle array and the absolute value of the refractive index of magnesium in the wavelength range of 400 to 2500 nm, and FIG. 7 illustrates the wavelength-dependent transmittance of the magnesium nanoparticle array in the wavelength range of 400 to 2500 nm, in comparison with a magnesium thin film composed of the same amount of magnesium as the magnesium nanoparticle array. In addition, FIG. 7 shows a top view and a side view of the magnesium nanoparticle array.

At this time, the refractive index of magnesium is a conventionally known value, and the value shown was measured using an ellipsometer. In addition, the effective refractive index and transmittance of the hemispherical magnesium nanoparticle array, as well as the transmittance of the magnesium thin film, were measured using Finite-Difference Time-Domain (FDTD) simulation. For the FDTD simulation measurements, a substrate coated with a 130 nm thick ITO layer on SiO₂ glass was used, and magnesium nanoparticles were formed on the upper surface of the substrate as shown in FIG. 8. The magnesium thin film was also formed on the same type of substrate, using the same amount of magnesium as the magnesium nanoparticle array, and was formed with a uniform thickness. At this time, the magnesium nanoparticles were arranged adjacent to each other, as shown in FIG. 3, and the radius of each magnesium nanoparticle was measured to be 20 nm. In addition, the incident light was p-polarized, with its oscillation direction set parallel to the x-axis, and was directed toward the substrate through the metal nanoparticle array using a wave vector of (k_{+Z}).

As can be seen from FIGS. 6 and 7, in the wavelength range of 400 nm to 550 nm where the effective refractive index value of the metal nanoparticle array is greater than the absolute value of the refractive index of a bulk metal of the same kind as the metal nanoparticles, the transmittance of the metal nanoparticle array is lower than that of the metal thin film. In conclusion, when the effective refractive index of the metal nanoparticle array is greater than the refractive index of a bulk metal of the same kind, it provides a significant advantage in reducing light transmittance compared to a metal thin film composed of the same amount of metal. Accordingly, transmittance can be significantly adjusted with the use of a smaller amount of electric energy, resulting in a significant advantage in terms of electrical efficiency.

In addition, as can be seen from the comparison between FIGS. 2 and 7, the hemispherical metal nanoparticle array exhibits a significantly wider wavelength range in which it shows superior light-blocking performance compared to the metal thin film, in terms of transmittance, than the spherical metal nanoparticle array. This may be attributed to the enhanced occurrence of the LSPR phenomenon in the case of hemispherical metal nanoparticles, as described above, which leads to an amplification of the surface plasmon effect. In conclusion, when the metal nanoparticles are hemispherical, they may provide superior performance in blocking light transmission compared to non-hemispherical shapes, and accordingly, the electrodeposition smart window may exhibit significantly improved electrical efficiency.

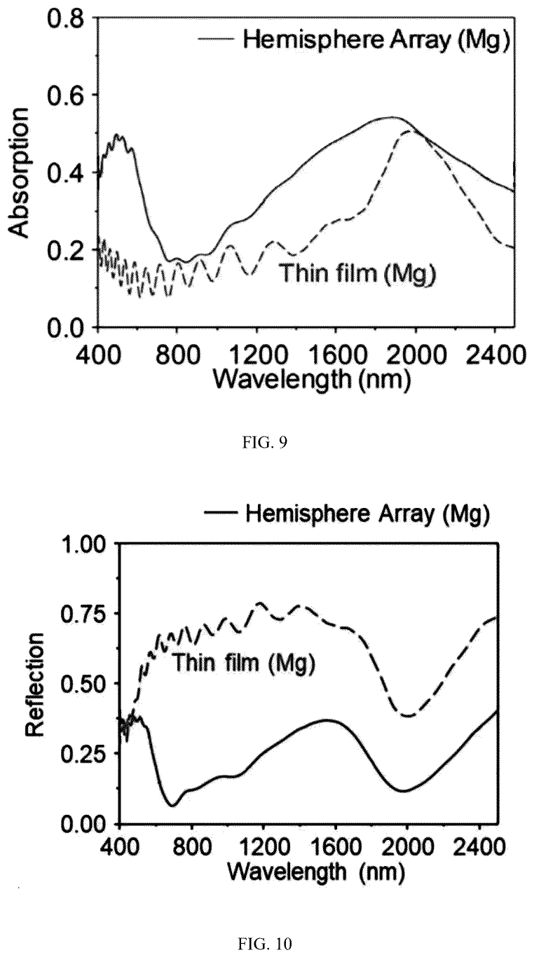

A more detailed explanation will be provided with reference to FIGS. 9 and 10.

FIG. 9 illustrates the results of the same simulation as in FIG. 7, but with the absorption rates of light measured for the hemispherical magnesium nanoparticle array and the magnesium thin film, and FIG. 10 illustrates the results of the same simulation as in FIG. 7, but with the reflectance of light measured for the magnesium nanoparticle array and the magnesium thin film.

As can be seen from FIG. 9, the magnesium nanoparticle array exhibits significantly enhanced absorption capability compared to the magnesium thin film. This improvement is attributed to the occurrence of surface plasmon effects, which lead to more effective light absorption. In addition, as can be seen from FIG. 10, the reflectance is significantly higher in the region where the effective refractive index value of the magnesium nanoparticle array is greater than the absolute value of the refractive index of magnesium, as compared with FIG. 6. As described above, the metal nanoparticle array exhibits an enhanced absorption pattern compared to the metal thin film due to the occurrence of the surface plasmon phenomenon. Consequently, in the region where the plasmon effect is maximized—specifically, where the effective refractive index of the magnesium nanoparticle array is greater than the absolute value of the refractive index of magnesium—the performance in blocking light transmission is exceptionally superior.

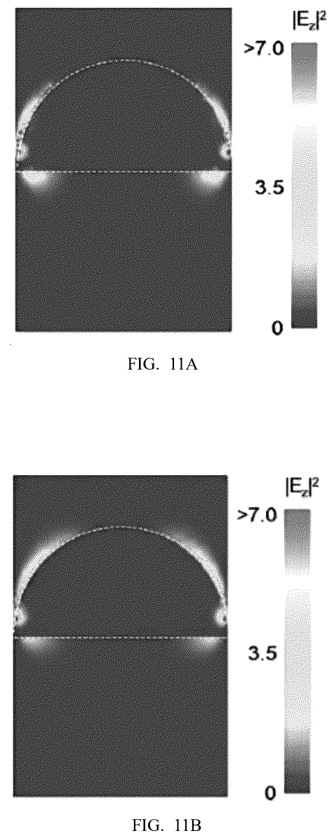

A more detailed explanation will be provided with reference to FIGS. 11A and 11B.

FIGS. 11A and 11B illustrate the results of analyzing the electric field profile of the E/component during the FDTD simulation performed as in FIG. 7, showing the intensity represented by |E_{Z}|². Since the plasmon phenomenon generates an electric field component parallel to the direction of light propagation, the magnitude of |E_{Z}|² serves as a direct indicator of the occurrence of the plasmon phenomenon. In this case, FIG. 11A corresponds to the case where the incident light has a wavelength of 500 nm, and FIG. 11B corresponds to the case where the incident light has a wavelength of 1000 nm.

As can be seen from FIGS. 11A and 11B, the LSPR phenomenon occurs with strong intensity in the hemispherical metal nanoparticles. In particular, as shown in FIGS. 11A and 11B, hemispherical nanoparticles exhibit superior LSPR generation, resulting in more effective blocking of light transmission compared to non-hemispherical counterparts.

More specifically, the electrodeposition smart window may be configured such that, for wavelengths in the range of 400 to 550 nm, the effective refractive index of the metal nanoparticle array is greater than the absolute value of the refractive index of a bulk metal of the same kind as the metal nanoparticles.

When the effective refractive index of the metal nanoparticle array is greater than the absolute value of the refractive index of a bulk metal of the same kind as the metal nanoparticles for wavelengths in the range of 400 to 550 nm, the surface plasmon phenomenon becomes particularly pronounced for light in the wavelength range of 400 to 550 nm, resulting in highly effective blocking of light within that range. In this case, the wavelength range of 400 to 550 nm corresponds to the visible light region, and when light blocking is highly effective within this range, it is particularly advantageous for effectively blocking sunlight.

More specifically, with reference to FIGS. 6 and 7 described above, in the case of the hemispherical magnesium nanoparticle array as discussed, the effective refractive index is greater than the absolute value of the refractive index of magnesium in the wavelength range of 400 to 550 nm. Accordingly, as can be seen from FIG. 7, in the wavelength range of 400 to 550 nm, it clearly exhibits superior performance in blocking light transmission compared to the magnesium thin film. This indicates that it is particularly effective in blocking light in the visible spectrum, which accounts for a large portion of sunlight.

More specifically, the Q_{LSPR} value of the bulk metal of the same kind as the metal nanoparticles may be 1 or greater at a wavelength of 550 nm. When the Q_{LSPR} value of the bulk metal of the same kind as the metal nanoparticles is 1 or greater at a wavelength of 550 nm, the occurrence of the surface plasmon phenomenon is enhanced in that wavelength range, thereby improving the performance in blocking light transmission. As a result, the electrodeposition smart window may be highly advantageous in terms of electrical efficiency. In addition, when the Q_{LSPR} value is 3 or greater at a wavelength of 550 nm, the electrodeposition smart window may be more advantageous in terms of electrical efficiency; when the value is 5 or greater, it may be even more advantageous; and when the value is 8 or greater, it may be most advantageous.

The strength of the LSPR generated by the metal nanoparticle structure is determined by the Q_{LSPR} value, which serves as a quantitative indicator. As the Q_{LSPR} value increases, the LSPR phenomenon occurs more strongly for each nanoparticle, thereby enabling the absorption of more light than the amount calculated by the conventional Beer-Lambert law.

This means that, ultimately, when the metal nanoparticle array is configured to have a higher Q_{LSPR} value, the increased light absorption capability allows a specific transmittance level to be achieved with significantly reduced electric energy consumption. In conclusion, when a metal with a high Q_{LSPR} value is used to form a metal nanoparticle array, the occurrence of the surface plasmon phenomenon is enhanced, resulting in a wavelength range where the effective refractive index of the metal nanoparticle array becomes greater than the absolute value of the refractive index of a bulk metal of the same kind. This provides significant advantages in blocking light transmission and, consequently, offers excellent performance in terms of electrical efficiency.

More specifically, the Q_{LSPR} can be calculated using Equations 1 through 4 below.

$$Refractive index = n + k i \qquad 〈 Equation 1 〉$$

n: real part of the refractive index
k: imaginary part of the refractive index

$$Re ( {ε}_{M} ) = {n}^{2} - {k}^{2} \qquad 〈 Equation 2 〉$$

Re(ε_{M}): real part of the complex permittivity

$$Im ( {ε}_{M} ) = 2 nk \qquad 〈 Equation 3 〉$$

Im(ε_{M}): imaginary part of the complex permittivity

$${Q}_{LSPR} = - \frac{Re ( {ε}_{M} )}{Im ( {ε}_{M} )} \qquad 〈 Equation 4 〉$$

According to Q_{LSPR} as calculated by Equations 1 through 4, the Q_{LSPR} is determined by the refractive index values. In this case, since the refractive index varies depending on the wavelength of light, the Q_{LSPR} likewise varies according to the wavelength of light. In this case, the Q_{LSPR} value increases or decreases in the same trend as the refractive index value. Therefore, when the Q_{LSPR} value is 1 or greater at 550 nm, the LSPR phenomenon occurs effectively, resulting in excellent performance in blocking light transmission.

More specifically, the metal nanoparticle array may include one or more selected from the group consisting of Mg, Ag+, Al, Pb, Ti, Zn, W, and Ni.

When the metal nanoparticle array includes one or more selected from the group consisting of Mg, Ag+, Al, Pb, Ti, Zn, W, and Ni, the occurrence of the surface plasmon phenomenon in the metal nanoparticle array may be enhanced, resulting in highly effective blocking of light transmission. Accordingly, an electrodeposition smart window with excellent electrical efficiency can be provided.

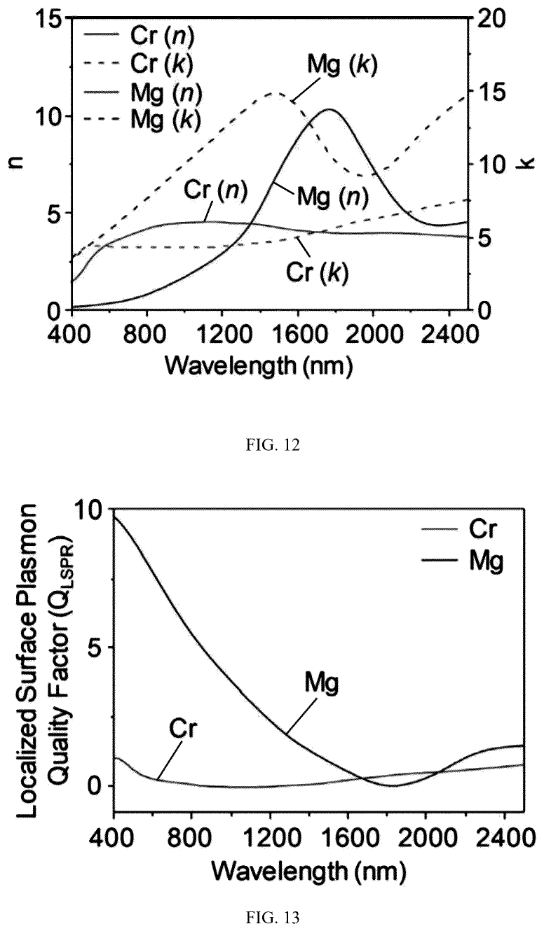

A more detailed explanation will be provided with reference to FIGS. 12 and 13.

FIG. 12 illustrates the variation of the real and imaginary parts of the complex refractive index of chromium and magnesium with respect to wavelength, and FIG. 13 illustrates the Q_{LSPR} values calculated for chromium and magnesium. As can be seen from FIGS. 12 and 13, the Q value varies depending on the refractive index values.

In this case, the Q_{LSPR} value of magnesium at a wavelength of 550 nm is 8.21, which is greater than 1, whereas the Q_{LSPR} value of chromium is 0.34, which is less than 1. Therefore, magnesium may be superior to chromium in terms of surface plasmon generation.

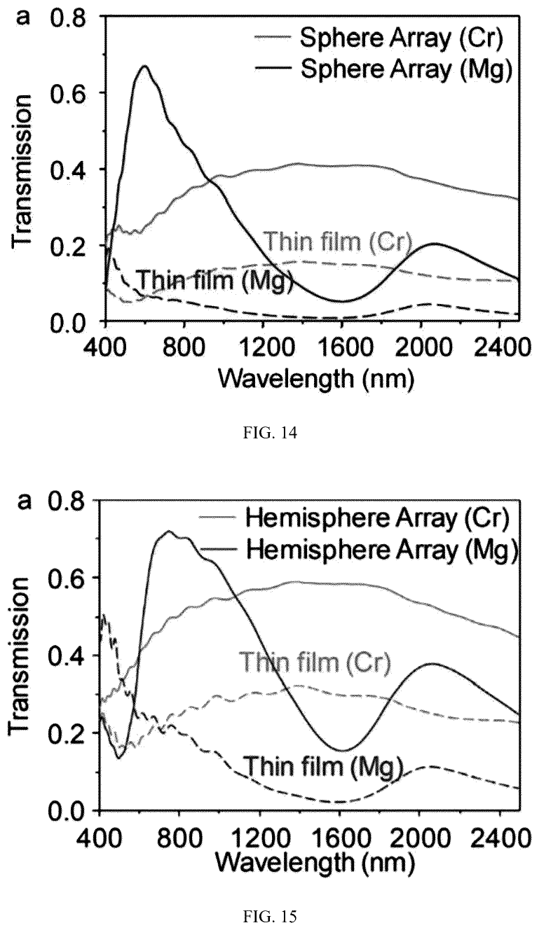

A more detailed explanation will be provided with reference to FIGS. 14 and 15.

FIG. 14 illustrates the results of an FDTD simulation conducted under the same conditions as in FIG. 2, except that magnesium and chromium were used as the metals, and the two cases are compared. In addition, FIG. 15 illustrates the results of an FDTD simulation conducted under the same conditions as in FIG. 7, except that magnesium and chromium were used as the metals, and the two cases are compared.

As can be seen from FIGS. 14 and 15, in the case of magnesium—which is one of the metals selected from the group consisting of Mg, Ag+, Al, Pb, Ti, Zn, W, and Ni—there exists a wavelength range in which the metal nanoparticle array, whether composed of spherical or hemispherical nanoparticles, exhibits superior light-blocking performance compared to a metal thin film composed of the same amount of metal. In contrast, for chromium, even when the nanoparticles are spherical or hemispherical, there is no wavelength range in which the metal nanoparticle array demonstrates better light-blocking performance than the corresponding metal thin film. This confirms that when the metal nanoparticle array includes one or more metals selected from the group consisting of Mg, Ag+, Al, Pb, Ti, Zn, W, and Ni, it exhibits excellent light-blocking performance, and accordingly, an electrodeposition smart window with outstanding electrical efficiency can be provided.

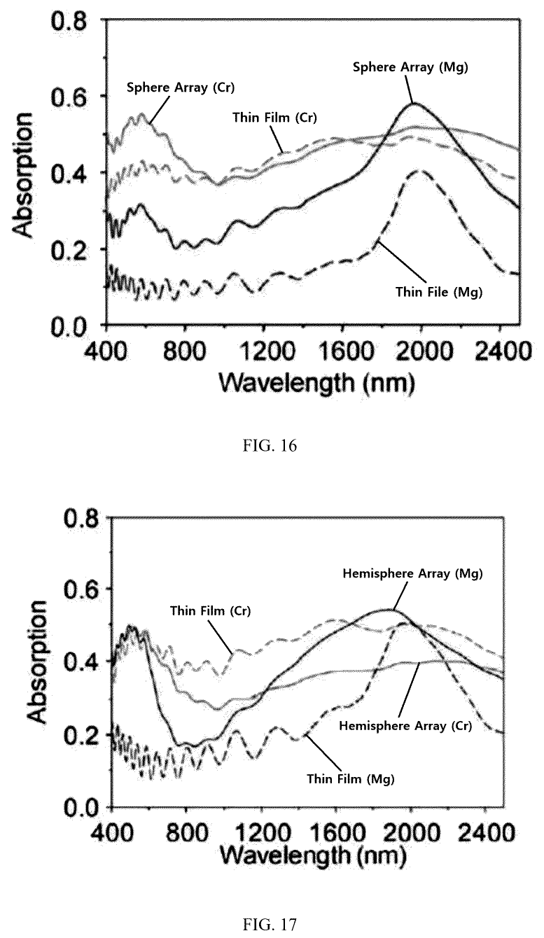

In addition, a more detailed explanation will be provided with reference to FIGS. 16 and 17.

FIG. 16 illustrates the results of an FDTD simulation conducted under the same conditions as in FIG. 4, except that magnesium and chromium were used as the metals, and the two cases are compared. In addition, FIG. 17 illustrates the results of an FDTD simulation conducted under the same conditions as in FIG. 9, except that magnesium and chromium were used as the metals, and the two cases are compared.

As can be seen from FIGS. 16 and 17, in the case of magnesium—which is one of the metals selected from the group consisting of Mg, Ag+, Al, Pb, Ti, Zn, W, and Ni—the metal nanoparticle array, even when composed of spherical or hemispherical nanoparticles, shows significantly superior light absorption performance compared to a metal thin film containing the same amount of metal. In contrast, for chromium, the light absorption is not superior to that of a metal thin film containing the same amount of metal. This confirms that when the metal nanoparticle array includes one or more metals selected from the group consisting of Mg, Ag+, Al, Pb, Ti, Zn, W, and Ni, the surface plasmon effect significantly enhances light absorption performance. Accordingly, an electrodeposition smart window with excellent electrical efficiency can be provided.

More specifically, the average radius of the metal nanoparticles may range from 10 to 350 nm.

In this case, the average radius of the nanoparticles can be measured through statistical analysis of experimental data obtained by observation using an electron microscope and atomic force microscopy (AFM).

More specifically, when metal nanoparticles are formed, localized surface plasmon resonance (LSPR), a type of surface plasmon resonance, occurs at the edges of the nanoparticles adjacent to the substrate, enabling the absorption of light. In addition, since the plasmon resonance phenomenon occurs between adjacent nanoparticles, controlling the distance between the nanoparticles is an important factor in inducing plasmon resonance. When plasmon resonance occurs, the absorbance of light increases due to the phenomenon, thereby effectively reducing light transmittance.

More specifically, the average distance between the nanoparticles may be equal to or greater than 2 times and equal to or less than 8 times the average radius of the nanoparticles.

In this case, if the average distance between the nanoparticles is greater than eight times the average radius of the nanoparticles, the spacing between the particles becomes too wide relative to the size of the nanoparticles, preventing near-field interactions caused by plasmon resonance between adjacent nanoparticles, which may reduce the effect of increased absorbance.

In addition, if the average distance between the nanoparticles is less than twice the average radius of the nanoparticles, the structure becomes similar to that of a metal film, which may hinder the effective induction of plasmon resonance at the edges of the nanoparticles, thereby reducing the enhancement in absorbance.

More specifically, the substrate may be any substrate commonly used in smart windows without particular limitation; however, preferably, a transparent and conductive base material may be used. In this case, more preferably, the transparent and conductive base material may be in the form of a transparent base material coated with a transparent conductive material. In this case, the transparent base material may include one or more selected from the group consisting of glass, PET (polyester), and PES (polyether sulfone), and preferably, it may be glass. In addition, the transparent conductive material coated on the transparent base material may include one or more selected from the group consisting of ITO (InSnO), InZnO, ZnO, InZnSnO, TiInZnO, NiInZnO, AZO(Al-doped ZnO), BZO(B-doped ZnO), and GZO (Ga-doped ZnO), and more preferably, it may be ITO.

More preferably, the substrate may be formed by coating inert metal nanoparticles on a transparent conductive material that has been coated on the transparent base material. The inert metal nanoparticles may be any electrically inert metal nanoparticles without particular limitation, but preferably include one or more selected from the group consisting of Pt, Au, Ru, Rh, Pd, Os, and Ir, and more preferably, may be Pt. The method of coating the inert metal nanoparticles is not particularly limited as long as it is a conventional method for coating inert metal nanoparticles, but preferably, a method may be used in which the base material coated with the conductive material is immersed in a dispersion of inert metal nanoparticles, or a spray coating method using the dispersion of inert metal nanoparticles may be employed. In this case, when a substrate without a coating of inert metal nanoparticles is used, electrodeposition may occur in a poor and aggregated form upon application of voltage, resulting in inadequate formation of proper nanoparticles, which may be disadvantageous in terms of achieving a reduction in transmittance. In conclusion, when a substrate coated with inert metal nanoparticles is used, aggregation of the deposited nanoparticles can be minimized compared to the case where such a coating is not applied. As a result, the light transmittance can be more effectively reduced upon application of voltage due to the surface plasmon effect, providing significantly enhanced performance.

According to a preferred embodiment of the present invention, the thickness of the conductive material coating on the substrate may range from 50 to 350 nm. In this case, if the thickness of the conductive material coating is less than 50 nm, the sheet resistance of the substrate may be relatively high. Additionally, if the thickness exceeds 350 nm, a problem of reduced transparency of the substrate may occur. In addition, the thickness of the transparent base material is not particularly limited and may be selected variously depending on the intended use; for example, it may range from 0.1 to 10,000 mm.

In addition, the electrochromic layer may include a metal nanoparticle array formed on the substrate upon application of a voltage and an electrolyte layer to be described later, and its thickness may range from 10 to 1000 nm. In this case, if the thickness of the electrochromic layer is less than 10 nm, sufficient optical transmission blocking may not occur, and heat transfer may be inefficient, which can be disadvantageous in terms of the operational performance of the smart window. On the other hand, if the thickness of the electrochromic layer exceeds 1000 nm, an excessive voltage drop may occur within the electrolyte, which can reduce the switching efficiency relative to the degree of optical transmittance control.

In addition, more specifically, the thickness of the metal nanoparticle array may range from 5 to 1000 nm. In this case, if the thickness of the metal nanoparticle array is less than 5 nm, sufficient optical transmission blocking may not occur, which can be disadvantageous in terms of the operational performance of the smart window. Conversely, if the thickness exceeds 1000 nm, the amount of charge required for the redox process involving the ions used in electrodeposition becomes excessive, which may result in reduced switching efficiency relative to the degree of optical transmittance control.

More specifically, the electrochromic layer may include an electrolyte layer, and the electrolyte layer may include a solvent and one or more selected from the group consisting of Mg²⁺, Ag⁺, Al³⁺, Pb²⁺, Ti⁴⁺, Zn²⁺, W⁶⁺, and Ni²⁺. In this case, the electrolyte layer may include metal ions of the same type as the metal in the metal nanoparticle array.

When the electrolyte layer includes one or more selected from the group consisting of Mg²⁺, Ag⁺, Al³⁺, Pb²⁺, Ti⁴⁺, Zn²⁺, W⁶⁺, and Ni²⁺, application of a voltage to the electrodeposition smart window may cause one or more ions selected from the group consisting of Mg²⁺, Ag⁺, Al³⁺, Pb²⁺, Ti⁴⁺, Zn²⁺, W⁶⁺, and Ni²⁺ to be deposited on the substrate to form a metal nanoparticle array.

In this case, one or more selected from the group consisting of Mg²⁺, Ag⁺, Al³⁺, Pb²⁺, Ti⁴⁺, Zn²⁺, W⁶⁺, and Ni²⁺ may be included in the electrolyte layer at a concentration ranging from 10 mM to 10 M. In this case, the concentration may be appropriately selected depending on the type of metal and the desired form of the metal nanoparticle array to be formed.

In this case, the solvent is not particularly limited as long as it can be used as a solvent in the electrodeposition process in which Mg²⁺, Ag⁺, Al³⁺, Pb²⁺, Ti⁴⁺, Zn²⁺, W⁶⁺, and Ni²⁺ are deposited as Mg, Ag, Al, Pb, Ti, Zn, W, Ni, or their oxides. However, preferably, the solvent may include one or more selected from the group consisting of polar aprotic solvents and ionic liquids, which are non-aqueous, do not contain hydrogen ions, and are capable of dissolving salts. More preferably, the solvent may include one or more selected from the group consisting of DMSO, acetonitrile, and acrylonitrile. In this case, when DMSO is used as the solvent, it may offer a cost advantage if the solvent is used in a highly dehydrated form and operated within an appropriate voltage range.

More specifically, the electrolyte layer may further include ions that are commonly included in the fields of smart windows and electrodeposition.

More specifically, the electrolyte layer may further include one or more polymers selected from the group of polymers commonly used as capping agents. Preferably, the electrolyte layer may further include one or more polymers selected from the group consisting of PVP, CTAB, CTAC, PEG, EDTA, and BSA, and more preferably, it may further include PVP. In this case, when the polymer is included in the electrolyte layer, it can suppress the formation of by-products and induce deposition conditions governed by diffusion limitation. As a result, a transmittance reduction effect comparable to or better than that achieved without the polymer can be obtained even with lower electric energy, thereby providing excellent performance in terms of electrical efficiency.

More specifically, in order to form the electrolyte layer in a gel form, the electrolyte layer may further include one or more selected from the group consisting of hydroxyethyl cellulose, polyvinyl acetate (PVA), and polyvinyl butyral (PVB). More specifically, this allows the liquid-form electrolyte layer to be converted into a gel form, which can be advantageous by enabling uniform color blocking through ion diffusion limitation and facilitating easier handling during the smart window fabrication process.

More specifically, the electrolyte layer may have a real part of the refractive index ranging from 1.0 to 3.0, and more preferably, from 1.2 to 2.5. When the real part of the refractive index of the electrolyte layer is in the range of 1.0 to 3.0, the light transmittance performance of the electrodeposition smart window including the metal nanoparticle array may be superior to that of an electrodeposition smart window including a metal thin film composed of the same type and amount of metal as the metal nanoparticle array.

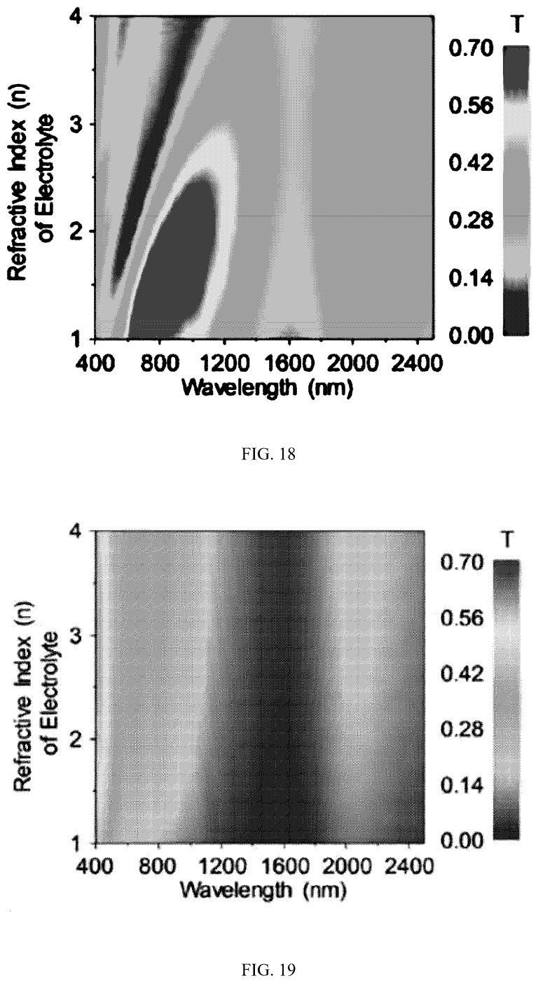

A more detailed explanation will be provided with reference to FIGS. 18 and 19.

FIG. 18 illustrates the results of a simulation using hemispherical magnesium nanoparticles as in FIG. 7, in which the real part of the refractive index of the electrolyte layer was varied and the transmittance of light was measured for each wavelength. In this case, the thickness of the electrochromic layer was set to 20 nm, and the simulation was performed under the assumption that the remainder of the electrochromic layer, excluding the magnesium nanoparticle array, was filled with the electrolyte layer.

FIG. 19 illustrates the results of an FDTD simulation conducted under the same conditions as in FIG. 18, except that it was assumed that a thin film composed of the same amount of magnesium as in the magnesium nanoparticle array was formed on the upper surface of the substrate. Similarly, the electrochromic layer was set to a thickness of 20 nm, and the simulation was performed under the assumption that the portion of the electrochromic layer excluding the magnesium thin film was filled with the electrolyte layer.

As can be seen from FIGS. 18 and 19, when the real part of the refractive index of the electrolyte layer is in the range of 1.0 to 3.0, the metal nanoparticle array exhibits a more superior effect in blocking light transmission, compared to a metal thin film composed of the same amount of metal, in the wavelength range of 400 to 1200 nm. In particular, when the real part of the refractive index of the electrolyte layer is in the range of 1.2 to 2.5, the metal nanoparticle array exhibits a more superior effect in blocking light transmission compared to a metal thin film composed of the same amount of metal, especially in the visible light range, thereby enabling more effective blocking of sunlight.

As such, the light-blocking effect can be controlled by adjusting the refractive index of the electrolyte layer, and the refractive index of the electrolyte layer may be appropriately selected to control the transmission of light in a desired wavelength range.

In addition, the voltage applied to the electrodeposition smart window according to the present invention may range from −1 to 1.5 V. In this case, if the applied voltage is lower than −1 V or higher than 1.5 V, electrolysis of auto-hydrated water vapor or electrolysis of the electrolyte may occur.

More specifically, the smart window according to the present invention may further include a counter electrode. In this case, the counter electrode may be electrically connected to the substrate according to the present invention.

In addition, more specifically, the counter electrode may include, as a component, the same metal as that included in the metal nanoparticle array to be formed. For example, when the metal nanoparticle array is composed of Mg, the counter electrode may include Mg.

In addition, more specifically, the counter electrode is not particularly limited as long as it is in a form commonly used as an electrode in smart windows. However, to ensure transparency, it may more specifically have a mesh structure or a frame structure with an open central region.

More specifically, the smart window according to the present invention may further include a transparent base material located on the opposite side of the substrate. In this case, the electrochromic layer and the counter electrode may be positioned between the transparent base material located on the opposite side of the substrate and the substrate. In this case, the transparent base material located on the opposite side of the substrate is not particularly limited as long as it can be used as an outer base material for smart windows, but more specifically, it may include one or more selected from the group consisting of glass, PET, and PES. In addition, the smart window according to the present invention may further include a sealing base material that surrounds the edges of the substrate and the transparent base material located on the opposite side of the substrate, so as to prevent the electrochromic layer from leaking to the outside. The sealing base material is not particularly limited as long as it is a base material that can commonly be used as an edge sealing component in smart windows.

In addition, the thickness of the transparent base material located on the opposite side of the substrate is not particularly limited and may be selected variously depending on the intended use; for example, it may range from 0.1 to 10,000 mm.

More specifically, the smart window according to the present invention may further include, in addition to the above-described components, other components that are commonly included in smart window structures.

In conclusion, the present invention provides an electrodeposition smart window with excellent electrical efficiency, in which a metal nanoparticle array is formed on the substrate upon application of a voltage. As a result of the surface plasmon effect, incident light can be effectively absorbed, thereby achieving a significant reduction in transmittance with a smaller amount of electric energy. When there exists a wavelength range in which the effective refractive index value of the formed metal nanoparticle array is greater than the absolute value of the refractive index of a bulk metal of the same kind as the metal nanoparticles, the performance in blocking light transmission in that wavelength range is significantly superior. This can be appropriately adjusted by varying the average radius of the metal nanoparticles included in the metal nanoparticle array, the distance between the particles, the concentration of ions in the electrolyte layer, and the refractive index of the electrolyte layer.

What is claimed is:

1. An electrodeposition smart window, comprising:
a substrate, and
an electrochromic layer formed on the substrate;
wherein, when a voltage is applied, the electrochromic layer comprises a metal nanoparticle array on the substrate, and
wherein, for light in a wavelength range of 400 nm to 2500 nm, an effective refractive index of the metal nanoparticle array is greater than a magnitude (i.e., an absolute value) of a refractive index of a bulk metal of a same kind as metal nanoparticles for at least a specific wavelength range.

2. The electrodeposition smart window of claim 1, wherein the metal nanoparticle array is formed by electrodeposition.

3. The electrodeposition smart window of claim 1, wherein the wavelength specific range is from 400 nm to 550 nm.

4. The electrodeposition smart window of claim 1, wherein the metal nanoparticle array comprises hemispherical nanoparticles.

5. The electrodeposition smart window of claim 1, wherein a Q_{LSPR} value of a metal of a same kind as that of the metal nanoparticle array is 1 or more at a wavelength of 550 nm of light.

6. The electrodeposition smart window of claim 1, wherein the metal nanoparticle array comprises one or more selected from the group consisting of Mg, Ag, Al, Pb, Ti, Zn, W, and Ni.

7. The electrodeposition smart window of claim 1, wherein an average radius of the metal nanoparticles is from 10 nm to 350 nm.

8. The electrodeposition smart window of claim 1, wherein an average interparticle distance of the metal nanoparticle array is equal to or greater than 2 times and equal to or less than 8 times an average radius of the metal nanoparticles.

9. The electrodeposition smart window of claim 1,
wherein the substrate comprises:
a transparent base material, and
a transparent conductive material coated on an upper surface of the transparent base material;
wherein the transparent base material comprises one or more selected from the group consisting of glass, polyethylene terephthalate (PET), and polyethersulfone (PES), and
the transparent conductive material comprises one or more selected from the group consisting of ITO (InSnO), InZnO, ZnO, InZnSnO, TiInZnO, NiInZnO, AZO(Al-doped ZnO), BZO(B-doped ZnO), and GZO (Ga-doped ZnO).

10. The electrodeposition smart window of claim 9,
wherein the substrate further comprises:
inert metal nanoparticles coated on an upper surface of the transparent conductive material;
wherein the inert metal nanoparticles comprise one or more selected from the group consisting of Pt, Au, Ru, Rh, Pd, Os, and Ir.

11. The electrodeposition smart window of claim 9, wherein the transparent conductive material has a thickness of 50 nm to 350 nm, and the electrochromic layer has a thickness of 10 nm to 1000 nm.

12. The electrodeposition smart window of claim 1, wherein the electrochromic layer comprises an electrolyte layer, and the electrolyte layer comprises a solvent and one or more selected from the group consisting of Mg²⁺, Ag⁺, Al³⁺, Pb²⁺, Ti⁴⁺, Zn²⁺, W⁶⁺, and Ni²⁺.

13. The electrodeposition smart window of claim 12, wherein a real part of a refractive index of the electrolyte layer is from 1 to 3.

14. The electrodeposition smart window of claim 12, wherein the electrolyte layer further comprises one or more selected from the group consisting of polyvinylpyrrolidone (PVP), cetyltrimethylammonium bromide (CTAB), cetyltrimethylammonium chloride (CTAC), polyethylene glycol (PEG), ethylenediaminetetraacetic acid (EDTA), and bovine serum albumin (BSA).

15. The electrodeposition smart window of claim 1, wherein the voltage is from −1 V to 1.5 V.
